(19) United States
(12) Patent Application Publication
(10) Pub. No.: US 2008/0315637 A1
(43) Pub. Date: Dec. 25, 2008

(54) MOTOR VEHICLE SEAT

(75) Inventors: Giuseppe Ghisoni, Milano (IT); Giorgio Ursino, Torino (IT)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 12/142,127

(22) Filed: Jun. 19, 2008

(30) Foreign Application Priority Data
Jun. 21, 2007 (IT) TO 2007 A000449

(51) Int. Cl. B60N 2/64

(52) U.S. Cl. 297/216.13

(57) ABSTRACT

A motor vehicle seat, having a covering secured to a supporting structure aligned with a central region by anchoring components located essentially along the perimeter of a base of a positioning recess.

### CROSS-REFERENCE TO RELATED APPLICATIONS

This application claims foreign priority benefits under 35 U.S.C. § 119(a)-(d) to Italian patent application No. TO 2007 A000449, filed Jun. 21, 2007, which is hereby incorporated by reference in its entirety.

### BACKGROUND OF THE INVENTION

1. Field of the Invention

The present invention relates to a motor vehicle seat.

2. Background Art

Motor vehicle seats typically consist of a seat section, a backrest, and a supporting structure to which are secured padding elements made of a non-rigid material. The padding elements are at least partially covered by respective coverings or covers that are secured to the rigid structure of the seat. The surfaces of the seat section and of the backrest, which are intended to support the body of an occupant of the seat, are defined by the corresponding cover, which is mounted in a stretched condition on the respective padding element.

For the purposes of aesthetic differentiation, motor vehicle seats have offered various different techniques for the implementation of the cover.

In some instances the covers are formed by stitching together a plurality of pieces of fabric that are different in terms of their appearance or color. For this purpose, the fabric intended to constitute one or more parts of the cover is overprinted with aesthetic and/or decorative patterns, for example, via the bonding or overprinting of a synthetic material.

Other solutions entail cover sections that can be replaced as desired (see, for example, European patent No. EP A 1 325 838). Solutions of this type offer manufacturers the option of differentiating the seats in a simple manner, while simultaneously allowing the ultimate users of the vehicle to replace part of the cover as needed (for example, to customize the seat).

It has also been proposed that the central region of the seat section and/or the backrest include a housing recess for a padded component. In these cases the shape of the padded component of the seat section and/or of the backrest presents a hollow or passage in the said central region, in which the majority of the above-mentioned padded component, whose shape is essentially that of a cushion, is seated.

In some instances the padded component is permanently affixed to the rest of the seat.

The purpose of this solution (which is employed, for example, by the present applicant in the manufacture of seats for sports cars and/or luxury vehicles) is essentially to confer upon the seat a particular aesthetic appearance.

However, in other instances, it has been proposed that the padded component be configured as a removable and/or replaceable part of the seat, with the inclusion of appropriate releasable anchoring means. For example, in French patent No. FR A-2 794 696 the padded component and the corresponding seat are shaped in such a way that a dovetail or tongue-and-groove joint is formed between the parts, with the addition of further coupling means, such as buttons or snap fasteners. Similarly, British patent No. GB A 2 263 396 specifies the use of anchoring devices that include shaped pins and slots. U.S. Pat. No. 5,690,384 suggests that the seat structure include mechanical bolts or latches intended to hold, in a releasable manner, the corresponding fasteners associated with the padded component, which moreover is equipped with alignment pins. This same document also proposes the use of Velcro® type fasteners to ensure that the padded component is held securely in the corresponding recess defined in the seat section. In U.S. Pat. No. 5,820,214, a first longitudinal extremity of the padded component is equipped with means that are suitable for being connected to corresponding fasteners associated with the seat structure, while the releasable anchoring means on the opposite end of the padded component consists of a zipper.

The solutions offered according to the state of the art are obviously relatively complex, in terms of both the creation of the padded component and the creation of the so called “fixed” part of the seat, to which the padded component must be secured in a removable manner. Some of these solutions are also manifestly unsafe, particularly when the means for anchoring the padded component are fastened only to the cover of the corresponding part of the seat.

### SUMMARY OF THE INVENTION

In view of the foregoing observations, the present invention proposes a motor vehicle seat of the type having at least one removable padded component, whose structure constitutes an improvement over the known solutions; that is easy to construct on the industrial level; and that exhibits a high degree of reliability during use. Another goal of the invention is to provide a solution that makes it possible to enhance the functionality of a seat that is equipped with a removable padded component of the type mentioned hereinabove.

These and other goals, which will become more clear hereinbelow, are achieved through the present invention by a motor vehicle seat that has the characteristics described in the attached claims. The claims constitute an integral part of the technical teaching provided herein with regard to the invention.

The goals, the characteristics, and the advantages of the present discovery will become clear from the following detailed description, which is offered with reference to the attached drawings, which are provided purely as non-limitative examples.

### BRIEF DESCRIPTION OF THE DRAWINGS

FIG. 1 is a diagrammatic perspective view of a motor vehicle seat according to the present discovery;

FIGS. 2 and 3 are diagrammatic perspective views of the seat shown in FIG. 1, in two different positions;

FIGS. 4 and 5 are diagrammatic cross-sectional views, along lines IV IV and V V, respectively, in FIG. 1; and

FIG. 6 is an enlarged detailed view of part of the structure shown in FIG. 5.

### DETAILED DESCRIPTION OF THE PREFERRED EMBODIMENT(S)

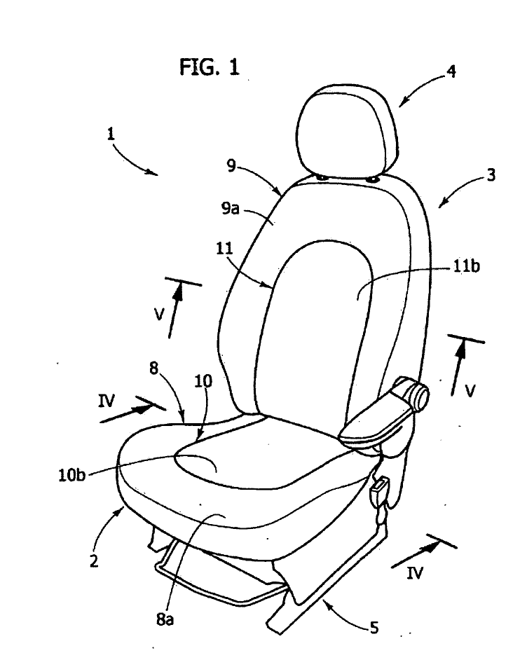

FIG. 1 shows a motor vehicle seat according to the present invention, designated overall as 1. In the example shown, the seat 1 is a front seat; however, the solution described hereinbelow can also be used in the construction of the back seats of motor vehicles.

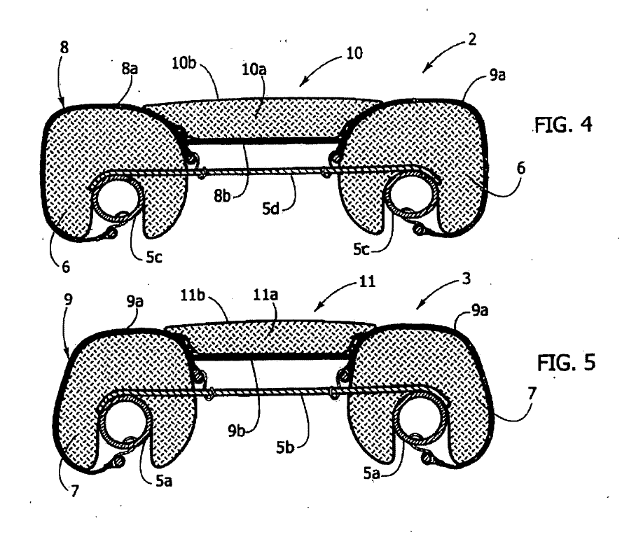

As in the current state of the art, the seat 1 consists of a seat section 2 and a backrest 3, the upper part of which includes a headrest 4. Likewise as in the current state of the art, the seat 1 also includes a supporting structure, designated overall as 5 in FIGS. 1 through 3, in which it is only partially visible. The supporting structure 5 includes a base that is mounted on the floor of the vehicle, optionally in a movable manner, with the use of sliding guide rails. A corresponding padding element, designated as 6 in FIG. 4, is secured to this part of the base. The structure 5 also includes a second part that is hinged to the above-mentioned part of the base so as to form a framework for the backrest 3. To this second part of the structure 5 of the seat is secured a corresponding padding element, designated as 7 in FIG. 5. In accordance with the current state of the art, the padding elements 6 and 7 are made of a non-rigid material, such as an expanded or foam-based material.

The seat section 2 and the backrest 3 are also provided with respective covers or coverings, designated overall as 8 and 9, respectively, which are mounted in a stretched condition on the respective padding elements 6 and 7.

The central region of the seat section 2 and the backrest 3 contain respective padded components, designated overall as 10 and 11. Components 10 and 11 are configured essentially as cushions, each of which is padded (designated as 10a and 11a in FIG. 4 and FIG. 5) and is enclosed by a respective cover or covering (designated as 10b and 11b in FIG. 4 and FIG. 5), which in particular consists of a fabric.

As noted, components 10 and 11 are operatively located in the central regions of the seat section 2 and the backrest 3, which contain corresponding positioning recesses. For this purpose, in the embodiment shown here in FIG. 4 and FIG. 5, the padding elements 6 and 7 are generally U-shaped, or in each instance possess a recess in a corresponding central region.

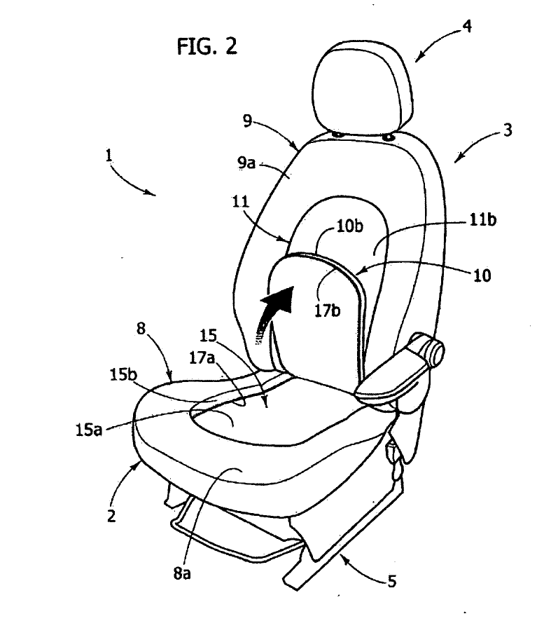

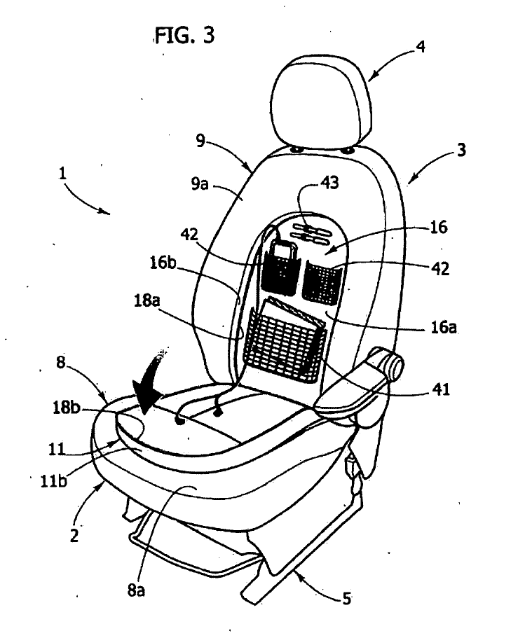

The above-mentioned positioning recesses are visible in FIG. 2 and FIG. 3, respectively, for component 10 and component 11, and are designated as 15 and 16 overall. The recess 15 has a base 15a and a lateral surface 15b; analogously, the recess 16 has a corresponding base 16a and a peripheral surface 16b.

The padded components 10 and 11 are secured, in a releasable manner, to the corresponding housing recesses 15 and 16, through means to which a user can gain access directly from the front part of the seat 1. In the currently preferred embodiment, a zipper fastener is provided for this purpose.

Each of the above-mentioned zipper fasteners includes a first zipper strip, designated as 17a and 18a in FIG. 2 and FIG. 3, each of which strips is secured (in particular, via a stitched seam) to the coverings 8 and 9 of the seat section 2 and of the backrest 3, respectively. Each zipper fastener also includes a second zipper strip, designated as 17b and 18b, each of which strips is secured (in particular, via a stitched seam) to the covering 10b or 11b of the respective padded component 10 or 11. Each of the two zipper fasteners also includes at least one respective zipper-pull, not shown in the figures. The zipper strips 17a and 18a preferably extend substantially along the entire perimeter of the base 15a or 16a of the respective recess 15 or 16, and the zipper strips 17b and 18b extend along the entire periphery of the respective padded components 10 and 11. In order to facilitate the sliding of the zipper-pulls, the recesses and the components preferably have a curved or rounded form in the respective corner areas.

In FIGS. 2 and 3 the above-mentioned zipper fasteners are shown in partially opened position, such that the corresponding padded components 10 and 11 are still partially connected to the covering 8 or 9 of the respective portions of the seat, namely, the seat section 2 and the backrest 3. In particular, the components 10 and 11 are still secured to the coverings 8 and 9, respectively, by means of the essentially rectilinear segment of the corresponding zipper fastener that is closest to the region of the union between the seat section and the backrest 3. As mentioned hereinabove, the component 10 is shown in the raised position, approaching the backrest 3 (FIG. 2), while the component 11 is lying down against the seat section 2 (FIG. 3). It should be noted that in actual practice, the two zipper fasteners used to anchor the components 10 and 11 may be opened completely, so as to allow the removal of the components 10 and 11 from the respective parts of the seat.

In one preferred embodiment of the invention, the peripheral surface 15b and 16b and the base 15a or 16a of each recess 15 or 16 consist of different parts of the covering 8 and 9 of the corresponding part of the seat 2 or 3. In particular, the peripheral surfaces 15b and 16b are defined by the first parts 8a and 9a of the covering 8 and 9, respectively.

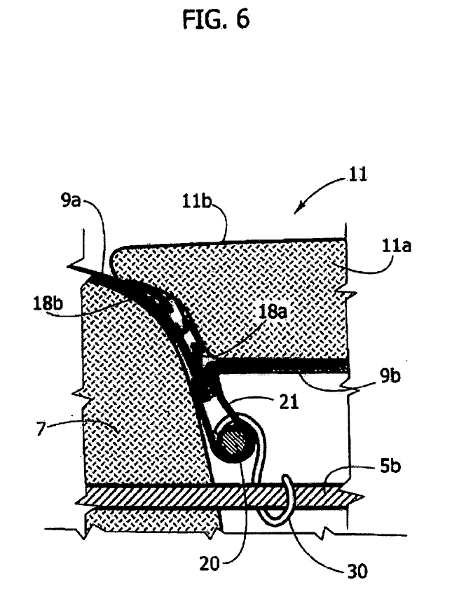

For the sake of simplicity, in the figures the first part of the covering 8a and 9a is shown as consisting of a single piece of material. In actual practice, however, the [first] part of the covering 8a and 9a consists of multiple pieces of fabric that are sewn together. In contrast, however, the base 15a and 16a of the recesses 15 or 16 consist of a second part of the covering 8 or 9 that is securely affixed to the first part of the covering 8a or 9a, designated as 8b or 9b only in FIG. 4 and FIG. 6.

In one possible embodiment, the part of the covering 8b or 9b that forms the base 15a or 16a of the recesses is made of a material (for example, a woven or a non-woven material) that is different from the one of which the first parts 8a and 9a are made. The areas that are normally hidden by the cover may be made of fabrics that are of lesser quality than the ones that are used to make the visible or exposed parts of the cover. Accordingly, the proposed solution makes it possible to reduce the upholstery costs, specifically because it allows a more economical fabric to be used to create the bases 15a and 16a. Obviously, there is no reason why these bases cannot be made from the same material that is used to make the parts 8a and 9a of the cover; however, such a solution may be more expensive.

Similarly, the piece of material that constitutes the base 15a or 16a of each recess may optionally consist of a single piece, i.e., the same piece that forms the cover for the peripheral surface 15b or 16b of the corresponding recess.

The first parts 8a and 9a and the second parts 8b and 9b of the covering are secured to the supporting structure 5 that is aligned with the above-mentioned central region of the seat section 2 and of the backrest 3. For this purpose, shared anchoring means are provided, which are located essentially around the perimeter of the base 15a and 16a of the corresponding positioning recess base 15 and 16.

One possible embodiment of the above-mentioned shared anchoring means is shown in the cross-sectional views in FIGS. 4 and 5, and also in the enlarged detailed view provided in FIG. 6. The detailed view in FIG. 6 refers to FIG. 5, and thus to the backrest 3. However, it should be noted that the anchoring means shown in this figure are analogous to the anchoring means used in the seat section 2.

With reference in particular to FIG. 6, the above-mentioned anchoring means for the first part 9a and the second part 9b of the covering 9 of the backrest 3 include a wire-type element, designated overall as 20, which, for example, may consist of a metal wire.

The element 20 is inserted in such a way that it passes through respective guide means, designated as 21. In the example shown, guide means are provided that are shaped essentially like a sheath, which may, for example, consist of a longitudinally extended strip of fabric folded back on itself, so as to surround the element 20. Alternatively, the guide means 21 may consist of a plurality of openings, spaced apart from each other, which may, for example, likewise be made of fabric.

The wire-type element and the corresponding guide means are located essentially around the perimeter of the base 15a or 16a of the positioning recess 15 or 16. In the preferred embodiment, the wire-type element 20 and the means 21 extend around the entire perimeter of the base 15a or 16a; however, the solution according to which the above-mentioned components are located only around three of the four sides of the base is not excluded. For example, with reference to FIGS. 2 and 3, the wire-type element 20 and the guide 21 may not extend along the side of the base 15a or 16a of the recess 15 or 16 that is closest to the area in which the seat section 2 meets the backrest 3.

With reference now to the detailed view shown in FIG. 6, in the first and second parts of the covering 9a and 9b, the respective edge regions are joined to each other and to the guide means 21 of the wire-type element 20. In addition to being joined to each other and to the guide means 21, the two parts 9a and 9b of the covering 9 are preferably also joined to the first zipper strip 18a.

In the example shown in FIG. 6, the peripheral regions of the two parts of the covering 9a and 9b enclose a portion (which may, for example, be made of fabric) of the zipper strip 18a. The resulting “sandwich” is in turn placed between the two edges of the strip of fabric folded in a U-shape so as to form the guide means 21. The resulting “package” is then sewn so as to join the various parts, i.e., the guide means 21, the parts of the covering 9a and 9b, and the zipper strip 18a. Obviously, other attachment methods made may be employed. For example, the peripheral regions of the parts of the covering 9a and 9b may be sewn together directly, and the edges of the sheath 21 may also be sewn directly to each other. The resulting parts may then be sewn to each other and to the zipper strip 18a. However, as can be inferred, there are many seam-stitching options.

In any event, as indicated in FIGS. 4 through 6, the assembly formed by the parts that are affixed to each other by means of seam stitching is then positioned essentially along the perimeter of the base 16a.

The shared anchoring means for the two parts of the covering 9a and 9b also includes a plurality of retaining devices. FIGS. 4 through 6 show only some of these retaining devices, designated as 30, which (purely for illustrative purposes) are configured in the form of small hooks, one end of which is engaged with the wire-type element 20. For this purpose, the corresponding guide sheath 21 may have, in certain specific areas, appropriate openings for the insertion of the hooklike end of a corresponding device 30. If the guide means for the wire-type element 20 consist of loops spaced apart from each other, then obviously the above-mentioned openings are not necessary.

The second end of the retaining devices 30 is attached to the supporting structure of the corresponding portion of the seat, which may be either the backrest 3 or the seat portion 2.

In the example shown in FIGS. 5 and 6, the portion of the structure shown is that of the backrest 3, which has at least two vertical elements, designated as 5a, between which extends one or more crosspieces, one of which is designated as 5b.

As can be seen, the devices 30 that are visible in FIGS. 5 and 6 are indeed affixed to the crosspiece 5b. It should be noted that for the sake of simplicity, in these figures the vertical elements 5a are shown as having tubular and circular cross-sections; in actual practice, however, the configuration of the vertical elements 5a of the portion of the supporting structure 5 that is present in the backrest 3 may be different; for example, these elements may have a C-shaped or U-shaped cross-section. Analogous considerations obviously also apply for the portion of the supporting structure that is visible in FIG. 5 with regard to the seat section 2. As can be seen in this figure, the supporting structure has two primary lateral elements, designated as 5c, which are assumed to be essentially parallel and between which extend one or more crosspieces, one of which is designated as 5d. In this instance it can be seen that the retaining devices 30, as shown in FIG. 5, are also affixed to the crosspiece 5c.

In another embodiment, the retaining devices 30, or parts thereof, whose shape is different from the shape shown in these figures, may be affixed directly to the vertical elements 5a or to the lateral elements 5c of the structure 5 of the seat.

The retaining devices 30 are located at a distance from each other, along the perimeter of the base of the housing recess of the corresponding padded component 10 or 11. For illustrative purposes, at least four retaining devices 30 may be provided for the seat section 2, whereas at least six retaining devices 30 may be provided for the backrest 3.

As mentioned hereinabove, the detailed view shown in FIG. 6 refers to the backrest 3; however, the anchoring means shown in this figure are analogous to the ones used with the seat section 2 (as shown in FIG. 4).

FIGS. 4 and 5 show the padding elements, designated respectively as 6 and 7, for the seat section 2 and the backrest 3. Likewise with reference to these elements, the figures should be understood as diagrammatic. Thus, in actual practice, the shape of the padding elements 6 and 7 may be different from the shape shown.

FIGS. 4 and 5 also show how the first parts of the covering 8a and 9aare affixed to the structure of the seat, likewise in relation to the peripheral region facing the central recess 15 or 16, and, in particular, in relation to the vertical elements 5a or the lateral elements 5c. The means used for this purpose may include wire-type elements, guide elements, and retention elements that are similar to the ones designated hereinabove as 20, 21, and 30.

The anchoring of the covering 8 and 9 in the opposing or facing regions is done in such a way that the resulting covering has an overall stretched configuration in relation to the corresponding part of the padding 6 and 7, taking advantage of the elasticity of the latter material.

If crosswise anchoring of the structure is desired, as in the example shown in FIGS. 4 and 6, the parts 8b and 9b preferably extend to a greater height in relation to the crosspieces 5b and 5d, specifically, in such a way that the base 15a or 16a does not rest directly on those crosspieces when the seat 1 is unoccupied. Nevertheless, it should be noted that the distance between the crosspieces 5b and 5d and the parts 8b and 9b is intentionally increased in the figures, for the sake of greater clarity of illustration.

The thickness of the parts of the covering 8b and 9b that form the base of the recesses 15 and 16 (which, for example, may or may not be made of a woven fabric) may be different from the thickness of the part of the covering 8a and 9a; however, this difference is not a mandatory element of the embodiment. Furthermore, the plate forming the base 15a or 16a is preferably, but not necessarily, more rigid than the first part of the covering 8a or 9a.

With reference now to FIG. 3, the base 16a of the recess 16 serves as the point of attachment for object-holder elements, which are accessible by a user when the corresponding padded component 11 is at least partially removed from the said recess. As noted hereinabove, FIG. 3 illustrates an example in which the padded component 11 is released only partially by the corresponding zipper fastener 17a or 17b, so that it can be folded back onto the seat section 2.

In the example shown, the above-mentioned object-holder elements include a plurality of essentially pocket-like elements, consisting, for example, of nets secured to the front of the base 16a. The object-holder elements, designated as 41, 42, and 43, may have different shapes and sizes, in order to contain different types of objects. For example, the pocket designated as 41, whose width is the greatest, may be used to hold a map or a datebook, while the pocket designated as 42, which is smaller, may be used to hold an electronic device, such as a cellular telephone or a portable satellite navigation unit. The example shown also includes pen-holders 43.

The fact that the base 16a of the recess 16 may be made of a material that is relatively thicker and/or more rigid than the rest of the covering makes it possible to provide a support that is strong enough to allow the object-holder elements to be attached.

Obviously, object-holder elements of any nature and shape may be associated with the base 16a of the recess 16. It is equally clear that the object-holder elements may also be affixed to the base 15a of the recess 15 that is present in the seat section 2.

As implied in FIG. 3, the option offered by this solution makes it possible to provide more space for the storage of objects in the passenger compartment of a vehicle, with the advantage that the objects in question are conveniently held in place. In daily practice, for example, objects of the type described hereinabove simply rest on the upper surface of the seat section, with the result that, in the event of sudden or unexpected braking or steering, the objects fall off the seat.

The use of the seat as described herein, with its ability to remove, in whole or in part, the padded component 10 or 11, is obviously very simple. All the user needs to do is to grasp the zipper-pull located in the small gap between the component 10 or 11 and the lateral surface 15b or 16b of the corresponding recess.

This maneuver is obviously facilitated by the fact that the component 10 or 11 is relatively yielding. Alternatively, the user can simply open the zipper fastener, either part of the way or all the way, as necessary, in order (for example) simply to gain access to the object-holders (as in the example shown in FIG. 3), or else in order to remove the padded component 10 or 11 altogether. Obviously, the padded component 10 or 11 can be returned to its operational position by performing in reverse the maneuvers described hereinabove for the removal of the said component (i.e., by seating the padded component between the edges of the zipper fastener and then closing the zipper fastener).

The foregoing description clearly explains the characteristics of the present invention, along with its corresponding advantages.

The type of anchoring described for the coverings 8 and 9 in relation to the recesses 15 and 16 ensures that the structure will be appropriately sturdy, for the purposes of the support and the releasable installation of the padded component 10 or 11. Furthermore, the type of installation described herein insures that the accurate and durable shape of the housing recess 15 or 16 for the padded component 10 or 11 will be preserved.

The said recess 15 16 itself is also strengthened if, in one optional implementation, when the said region is subjected to greater stress during the use of the seat, a layer of material is used that is more rigid than the remainder of the covering of the seat section or of the backrest. In any event, the proposed solution is extremely simple and economical from a manufacturing point of view and in terms of the assembly of the seat. From this perspective, as mentioned hereinabove, the material that constitutes the base of the recesses 15 and 16 may be of lesser quality, or may be more economical, than the rest of the cover.

The base of the housing recess may be used for the installation of object-carrier elements, so as to enhance the functionality of the seat.

It is clear that numerous potential variants of the invention described as an example are available to, and can be implemented by, those skilled in the art, without in so doing departing from the scope of the discovery as defined in the following claims.

For example, it should be noted that fasteners of the Velcro® type may also be used to secure, in a releasable manner, the padded components to the corresponding housing recess, with part of the Velcro® fastener being secured directly to the base of the recess 15 and/or 16. Furthermore, if snap-button type fasteners are used, some of them may be secured directly to the material of which the base 15 and/or 16 is made.

The covering 10b or 11b of the padded component 10 or 11 may be configured in the form of a cover that can be removed, for example, in order to be washed and/or replaced, as desired.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A motor vehicle seat, having a seat section, a backrest, and a supporting structure, to which are secured padding elements that are part of the seat section and the backrest, respectively, with the seat section and the backrest including coverings that are secured to the structure and that cover, at least partially, the respective padding elements, and in which either the seat section or the backrest, or both, have a central region in which a positioning recess for a padded component is provided, with the said positioning recess having a base and a peripheral surface, characterized by the fact that the base and the peripheral surface of the recess are defined by respective regions of the covering of the seat section or of the backrest, respectively, with the covering being secured to the supporting structure aligned with the said central region by anchoring means, located essentially along the perimeter of the base of the positioning recess.

2. A seat according to claim 1, in which the peripheral surface is defined by a first covering portion of the seat section or of the backrest, respectively, and the base is defined by a second covering portion secured to the first covering portion, with the first and second covering portions being jointly secured to the supporting structure in alignment with the said central region by the said anchoring means.

3. A seat according to claim 1, in which the anchoring means include a wire-type element, particularly a metal wire-type element, passing through the respective guide means, which include, in particular, at least one longitudinally extended sheathing element and a plurality of openings spaced apart from each other.

4. A seat according to claim 3, in which the first part and the second part of the covering have respective peripheral regions that are joined to each other and with respect to the guide means of the wire-type element, particularly by means of a stitched seam.

5. A seat according to claim 3, in which the shared anchoring means include a plurality of retaining devices, located along the length of the wire-type element and spaced apart from each other, with each retaining device having a first extremity seated in the wire-type element and a second extremity seated in the supporting structure.

6. A seat according to claim 1, further including means for holding, in a releasable manner, the padded component in the housing recess.

7. A seat according to claim 6, in which the securing means include a zipper with a first zipper strip secured to a covering of the padded component and a second zipper strip secured to the covering of the seat section or of the backrest, respectively.

8. A seat according to claim 3, in which the first and second parts of the covering have respective peripheral regions that are joined to each other and with respect to both the second zipper strip and the guide means of the wire-type element.

9. A seat according to claim 1, in which to the base of the positioning recess are secured one or more object-holder elements, particularly in the form of pockets or similar elements, which are accessible by a user when the padded component is at least partially removed from the housing recess.

10. A seat according to claim 1, in which a said housing recess is present in a central region of the backrest and in which at least one part of the anchoring means is secured to a vertical element and/or to a crosspiece that is part of the supporting structure and that is aligned with the backrest.

11. A seat according to claim 1, in which a said housing recess is present in a central region of the seat section and in which at least one part of the anchoring means is secured to a lateral element and/or to a crosspiece that is part of the supporting structure and that is aligned with the seat section.

12. A seat according to claim 1, in which both the said seat section and the said backrest have, in a respective central region, a respective positioning recess for a respective padded component.

13. A motor vehicle seat having a seat section, a backrest, and a supporting structure, to which are secured padding elements that are part of the seat section and the backrest, respectively, with the seat section and the backrest including coverings that are secured to the structure and that cover, at least partially, the respective padding elements, and in which either the seat section or the backrest, or both, have a central region in which a positioning recess for a padded component is provided, with the said positioning recess having a base and a peripheral surface defined by the covering of the seat section or of the backrest, respectively, in which to the base of the positioning recess are secured one or more object-holder elements, particularly in the form of pockets or similar elements, which are accessible by a user when the padded component is at least partially removed from the housing recess.
